(19) United States
(12) Patent Application Publication
(10) Pub. No.: US 2010/0023479 A1
(43) Pub. Date: Jan. 28, 2010

(54) HEXADECIMAL FILE FAST DECOMPRESSION METHOD

(75) Inventor: Oliver Russell Fenton, Southampton (GB)

Correspondence Address: DUKE W. YEE;YEE & ASSOCIATES, P.C., P.O. BOX 802333, DALLAS, TX, 75380, US

(73) Assignee: Inernational Business Machines Corporation, Armonk, NY (US)

(21) Appl. No.: 12/179,364

(22) Filed: Jul. 24, 2008

(51) Int. Cl. G06F 17/30

(52) U.S. Cl. 707/2; 707/E17.044

(57) ABSTRACT

A computer implemented method of selectively accesses a set of subdivisions of a compressed file, wherein the compressed file is a hex dump file. A request to access a first data byte string is received. The first data byte string has a first address from within the compressed file. The compressed file comprises a plurality of subdivisions. Each of the plurality of subdivisions is provided with an address range to indicate the addresses of byte strings contained therein. The address range for each of the plurality of subdivisions is the file name for each of the plurality of subdivisions. A set of subdivisions from the plurality of subdivisions is identified that contains a first data byte string. The step of identifying the set of subdivisions comprises comparing the first address to the address range for the plurality of subdivisions. Only the set of subdivisions which contains the first data byte string is extracted.

### BACKGROUND OF THE INVENTION

1. Field of the Invention

The present invention relates generally to computer implemented methods. More specifically, the present invention relates to a computer implemented method for selectively accessing a set of subdivisions of a compressed file.

2. Description of the Related Art

A core dump is the recorded state of the working memory of a computer program at a specific time, generally when the program has crashed. Other key pieces of program state can also be included in the core dump, including the processor registers, which may include the program counter and stack pointer, memory management information, and other processor and operating system flags and information. A hexadecimal dump file, or “hex dump” file is a digital file of a core dump recorded in hexadecimal code.

The hex dump files are generally transferred to a service department or data center for analysis. Careful examination of a hex dump file often provides a service provider with insights into why a crash or other error has occurred. If the hex dump file was produced from a server, or server farm in a large computing environment, a typical hex dump file regularly contains several gigabytes of data. In order to save bandwidth and file space during transmission to a service department, the entire file is then typically compressed prior to transmission.

The hex dump file must then be uncompressed at the service department so that the memory location in question can be examined. Depending on the size and compression method that was utilized, complete decompression of the hex dump file can take several hours, and monopolize huge amounts of storage space.

### SUMMARY OF THE INVENTION

A computer implemented method of selectively accessing a set of subdivisions of a compressed file, wherein the compressed file is a hex dump file. A request to access a first data byte string is received. The first data byte string has a first address from within the compressed file. The compressed file comprises a plurality of subdivisions. Each of the plurality of subdivisions is provided with an address range to indicate the addresses of byte strings contained therein. The address range for each of the plurality of subdivisions is the file name for each of the plurality of subdivisions. A set of subdivisions from the plurality of subdivisions is identified that contains a first data byte string. The step of identifying the set of subdivisions comprises comparing the first address to the address range for the plurality of subdivisions. Only the set of subdivisions which contains the first data byte string is extracted.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a high level data flow depicting the various components according to an illustrative embodiment;

FIG. 4 is a process for compressing a dump file according to an illustrative embodiment; and

FIG. 5 is a process for selectively extracting a byte string from an indexed compressed file according to an illustrative embodiment.

### DETAILED DESCRIPTION OF THE PREFERRED EMBODIMENT

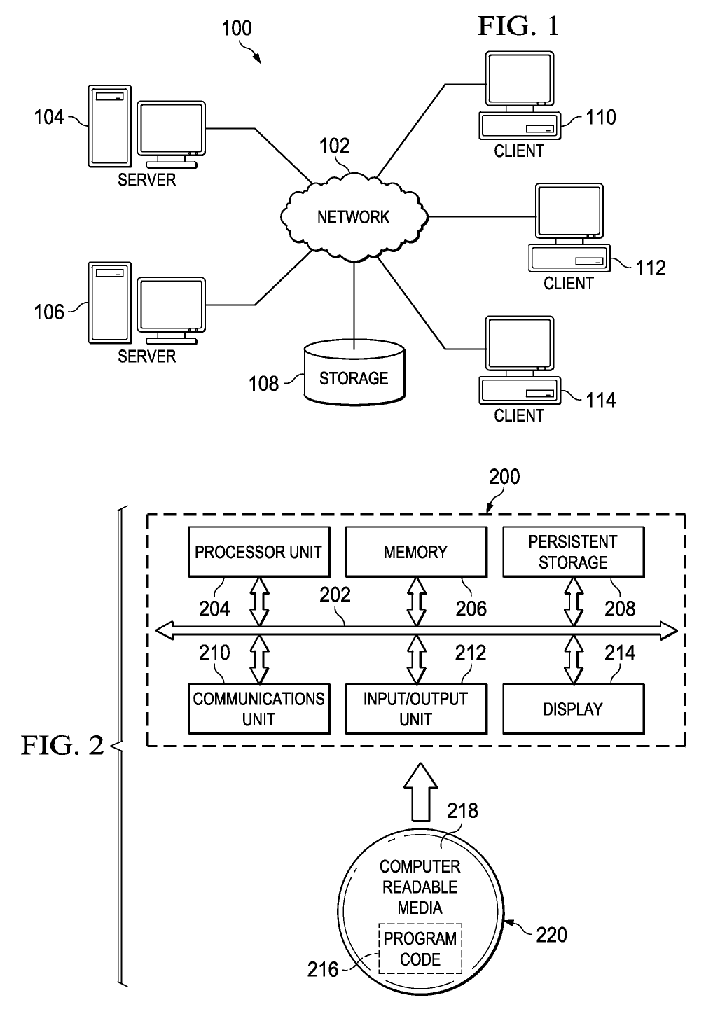

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments provide a computer implemented method of selectively accessing a set of subdivisions of a compressed file, wherein the compressed file is a hex dump file. A request to access a first data byte string is received. The first data byte string has a first address from within the compressed file. The compressed file comprises a plurality of subdivisions. Each of the plurality of subdivisions is provided an address range to indicate the addresses of byte strings contained therein. The address range for each of the plurality of subdivisions is the file name for each of the plurality of subdivisions. A set of subdivisions from the plurality of subdivisions is identified that contains a first data byte string. The step of identifying the set of subdivisions comprises comparing the first address to the address range for the plurality of subdivisions. Only the set of subdivisions which contain the first data byte string is extracted.

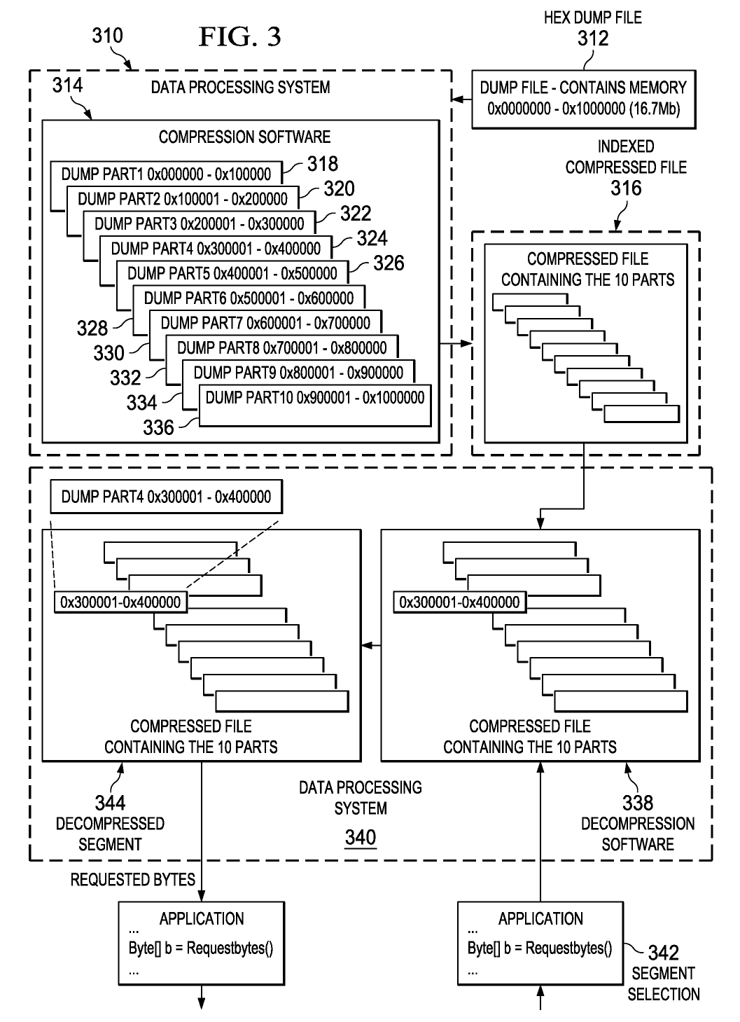

Referring now to FIG. 3, a high level data flow is shown depicting the various components according to an illustrative embodiment. The components of FIG. 3 can be implemented in a data processing system, such as data processing system 200 of FIG. 2.

Data processing system 310 performs a system dump to generate hex dump file 312. Hex dump file 312 is then sent to compression software 314 for compression.

Compression software 314 is a software process for compressing hex dump file 312. Compression software 314 can utilize a lossless compression algorithm. Compression software 314 can compress hex dump file 312 into a variety of available or proprietary compressed formats, including, for example, but not limited to, .zip, .rar, .cab, .jar, .pkz, and .sqx.

Compression software 314 compresses hex dump file 312 into indexed compressed file 316. Indexed compressed file 316 is a compressed file containing indexed contents of hex dump file 312. When compression software 314 compresses hex dump file 312, hex dump file 312 is partitioned into consecutive subdivisions 318-336. Subdivisions 318-336 are partitioned sections of hex dump file 312 which each contain a specific address range of hex dump file 312. Each of subdivisions 318-336 is assigned a file name corresponding to the specific address range contained within that subdivision. Subdivisions 318-336 are then compressed into a single compressed file, indexed compressed file 316.

Indexed compressed file 316 is then forwarded to decompression software 338 on data processing system 340. Data processing system 340 is a data processing system such as data processing system 200 of FIG. 2. Decompression software 338 is a software component executing on data processing system 340 that is capable of extracting and decompressing the various subdivisions 318-336 from indexed compressed file 316.

Segment selection 342 is entered into data processing system 340. Segment selection 342 is a user input specifying a requested data byte string having an address within hex dump file 312. Decompression software 338 compares the address within segment selection 342 to the various address ranges of subdivisions 318-336. Because the address ranges for subdivisions 318-336 correspond to the file names for subdivisions 318-336, decompression software 338 compares the address within segment selection 342 to the file names for subdivisions 318-336.

When decompression software 338 determines that the requested address is within the address ranges indicated by the file name for one of subdivisions 318-336, decompression software 338 extracts that corresponding subdivision in indexed compressed file 316. Decompression software 338 then decompresses that corresponding subdivision to create decompressed segment 344. Decompressed segment 344 is that partitioned section of hex dump file 312 which contains the memory locations specified by the address within segment selection 342. The remaining non-corresponding subdivisions are left in their compressed state within indexed compressed file 316. Decompressed segment 344 can then be viewed by a user.

In one illustrative embodiment, segment selection 342 can contain a range of requested addresses. In this embodiment, decompression software 338 will extract each of those subdivisions 318-336 which contain at least a portion of the range of requested addresses. In the case of extracting one, or more than one subdivision, the extracted subdivisions form a set.

In another illustrative embodiment, a second segment selection can be entered. The address of the second segment selection is first compared to decompressed segment 344 to determine if decompressed segment 344 contains the requested address of the second segment selection. If the requested address is contained within decompressed segment 344, decompression software need not decompress any of the other non-corresponding subdivisions 318-336. The requested address is simply retrieved from decompressed segment 344.

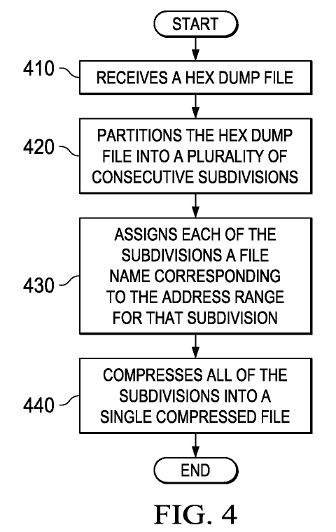

Referring now to FIG. 4, a process for compressing a dump file is shown according to an illustrative embodiment. Process 400 is a software process executing on a software component such as compression software 314 of FIG. 3.

Process 400 begins by receiving a hex dump file (step 410). The hex dump file can be hex dump file 312 of FIG. 3.

Process 400 then partitions the hex dump file into a plurality of consecutive subdivisions (step 420). The subdivisions are partitioned sections of the hex dump file. Each subdivision contains data byte strings for a specific address range of hex dump file.

Process 400 then assigns each of the subdivisions a file name corresponding to the address range for that subdivision (step 430). That is, each subdivision is assigned a file name based on the address range of the hex dump file contained within that specific subdivision.

Process 400 then compresses all of the subdivisions into a single compressed file (step 440), with the process terminating thereafter. The single compressed file can be indexed compressed file 316 of FIG. 3. The indexed compressed file can then be sent to a data center or service center for analysis.

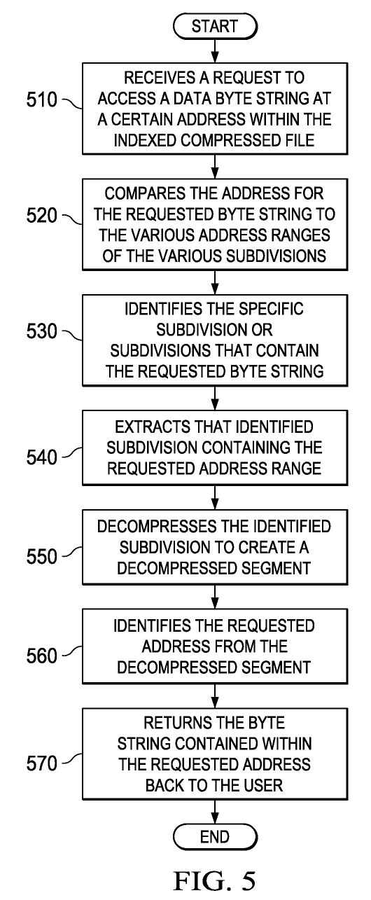

Referring now to FIG. 5, a process for selectively extracting a byte string from an indexed compressed file is shown according to an illustrative embodiment. Process 500 is a software process executing on a software component, such as decompression software 338 of FIG. 3.

Process 500 begins by receiving a request to access a data byte string at a certain address within the indexed compressed file (step 510). The request can be segment selection 342 of FIG. 3.

Process 500 then compares the address for the requested byte string to the various address ranges of the various subdivisions (step 520). Because the address ranges for subdivisions correspond to the file names for the subdivisions, process 500 needs only to compare the address for the requested byte string to the file names for the subdivisions.

Process 500 then identifies the specific subdivision or subdivisions that contain the requested byte string (step 530). That is, process 500 identifies which subdivision or subdivisions indicate an address range corresponding to the requested byte string. Because the names of each of the subdivisions indicate the addresses of byte strings contained therein, the file names for each subdivision can be examined or parsed to determine the address ranges contained therein.

Process 500 then extracts that identified subdivision containing the requested address range (step 540). The identified subdivision can be extracted from a storage or memory of a data processing system, such as data processing system 340 of FIG. 3. Process 500 then decompresses the identified subdivision to create a decompressed segment (step 550). The decompressed segment is that partitioned section of a hex dump file which contains the memory locations of the identified segment. The remaining non-identified subdivisions are left in their compressed state within the indexed compressed file.

Process 500 then identifies the requested address from the decompressed segment (step 560), and returns the byte string contained within the requested address back to the user (step 570). Process 500 terminates thereafter.

The illustrative embodiments provide a computer implemented method of selectively accessing a set of subdivisions of a compressed file, wherein the compressed file is a hex dump file. A request to access a first data byte string is received. The first data byte string has a first address from within the compressed file. The compressed file comprises a plurality of subdivisions. Each of the plurality of subdivisions is provided an address range to indicate the addresses of byte strings contained therein. The address range for each of the plurality of subdivisions is the file name for each of the plurality of subdivisions. A set of subdivisions from the plurality of subdivisions is identified that contains a first data byte string. The step of identifying the set of subdivisions comprises comparing the first address to the address range for the plurality of subdivisions. Only the set of subdivisions which contains the first data byte string is extracted.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method of selectively accessing a set of subdivisions of an indexed compressed file, wherein the indexed compressed file is a compressed hex dump file, the method comprising:
receiving by a processor a request to access a first data byte string having a first address from within the compressed file, wherein the compressed file comprises a plurality of subdivisions, and wherein each of the plurality of subdivisions is provided an address range to indicate the addresses of byte strings contained therein, wherein the address range for each of the plurality of subdivisions is a file name for each of the plurality of subdivisions;
identifying by a processor a set of subdivisions from the plurality of subdivisions that contain the first data byte string, wherein the step of identifying the set of subdivisions comprises comparing the first address to the address range for the plurality of subdivisions; and
extracting by a processor only ones of the set of subdivisions which contain the first data byte string.
